(19) United States
(12) Patent Application Publication
(10) Pub. No.: US 2009/0030967 A1
(43) Pub. Date: Jan. 29, 2009

(54) Personal wearable microserver

(75) Inventor: David C. Loda, Bolton, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/920,569

(22) PCT Filed: May 17, 2006
(86) PCT No.: PCT/US2006/019110

§ 371 Date: Nov. 16, 2007

Related U.S. Application Data
(60) Provisional application No. 60/681,695, filed on May 17, 2005.

(51) Int. Cl. G06F 15/16

(52) U.S. Cl. 709/201; 709/217

(57) ABSTRACT

An integrated system includes comprising a microserver integrated with a movable platform and in communication with one or more data collection apparatus disposed about a living organism, one or more microserver subsystems integrated within the microserver, and means for enabling two-way communications with the server from a remote location. The server hosts a webpage that is remotely accessible by the means for enabling two-way communications and capable of monitoring, retrieving, storing, analyzing and sending a set of data about the living organism from and to the server and one or more data collection apparatus.

### BACKGROUND OF THE INVENTION

The present invention relates generally to a personal microserver system enabling two-way global communications through a world wide web. More specifically, the present invention relates to a personal wearable microserver configured to function as the individual's personal gateway to digitally communicate with its environment both locally and remotely.

There are many contexts in which a digital interface between an individual and its environment would improve an individual's quality of life and in some cases, be life saving. For example, in the medical industry, there is a need for increased monitoring and communication of an individual's physiological conditions. Communications between medical providers and patients are limited to office visits, telephone communications and written communications. In some cases, a medical provider makes decisions without specific data that may be crucial, or at the very least helpful, to ascertaining an accurate diagnosis. Patient monitoring is constrained by limited access to the patient at the medical facility.

Medical research is similarly constrained due to limited access to test subjects and limited data from those subjects tested. For example, for a medical provider to monitor a specific type of behavior in a test subject, the test subject usually must be present at the scene, and in most cases, attached to monitors.

Various medical systems have been developed that include a monitoring device that may be worn by an individual and is configured to collect data from the individual. The monitoring device may also be configured to communicate such data back to a central server located remotely from the individual that processes the data into usable information. However, one limitation of many of these systems is that they are only configured for monitoring one condition and do not have the flexibility to be upgraded. Another limitation of these systems is that they do not have the capability to function as their own web based server, and instead function only as a client, requiring the data to be sent to a central server for use as an individual computer processing data in a stand-alone configuration.

There is a need for a small, wearable server that functions both as a stand-alone computer and as a web based server designated to an individual to provide local data-to-knowledge conversion linked with two-way global communications through the world wide web. As such, the individual would be able to digitally interact with his or her environment both locally and remotely.

### BRIEF SUMMARY OF THE INVENTION

The present invention relates to an integrated system for creating a digital interface between a living organism and its environment locally and remotely. The system includes data collection apparatus disposed on or around the living organism, and a microserver configured to be located inside, on or in close proximity to the living organism. The microserver is configured to function as a local computing workstation and a web data gateway having its own web page and corresponding Internet web address on a world wide web. The microserver is in communication with the data collection apparatus and is capable of retrieving, monitoring and analyzing data from the data collection apparatus.

### BRIEF DESCRIPTION OF THE DRAWINGS

FIG. 1 is a schematic of the present invention of a personal microserver system as part of a global Internet/world wide web matrix.

FIG. 1A is an exploded view of a microserver from FIG. 1 to illustrate how the microserver functions as a communications gateway between a person and its environment.

FIG. 2 is a schematic that illustrates use of a personal wearable microserver of the present invention in conjunction with an aircraft microserver system.

FIG. 3 is a schematic that illustrates use of a personal wearable microserver of the present invention in conjunction with a building network system.

### DETAILED DESCRIPTION

A personal microserver system of the present invention is configured to be worn on or inside, an individual and function as the individual's digital interface or gateway to its environment. The personal microserver system has the capability to monitor the individual, collect data about the individual, and disseminate the data to parties designated by the individual, while also restricting access to the data to those parties designated by the individual. Because the microserver operates as an Internet based web server, it is configured for two-way global communications through the world wide web. A similar microserver system is described in the following published applications, which are incorporated by reference in their entireties: U.S. Patent Application Pub. No. US 2003/0105565; and U.S. Patent Application Pub. No. US 2003/0163591.

The microserver system creates an open architecture system configured and reconfigurable to perform many applications and roles for an individual. The open architecture system created by the microserver allows for mass customization to convert various forms of data into usable knowledge without having to install or create new pieces of hardware for each application. Communications to and from the microserver may be through a wired or wireless connection, through satellite, cellular phones, wireless local area networks (WLAN), radio, cable or any other communications means.

The microserver creates a miniature, self-contained world wide web around the individual. This local world wide web facilities local access to data from the microserver using any type of computing device located within the local world wide web. The microserver also hosts a web page dedicated to the individual, and the web page has a corresponding Internet web address, making it possible to access data from the microserver from any remote location as well.

The microserver acts a data-communications gateway between an individual and his or her environment, which includes other individuals and entities. The microserver may be configured such that the communications to and from the microserver may be through voice and/or text communications means.

The term “microserver” as used herein is a mobile web server that is configured to function as a local computing workstation and as a web data gateway with its own web page and corresponding Internet web address on the world wide web. The web data gateway acts as a remote interface to control the functionality of the workstation. The microserver is part of a cluster of servers or networks that are arranged into hierarchical layers.

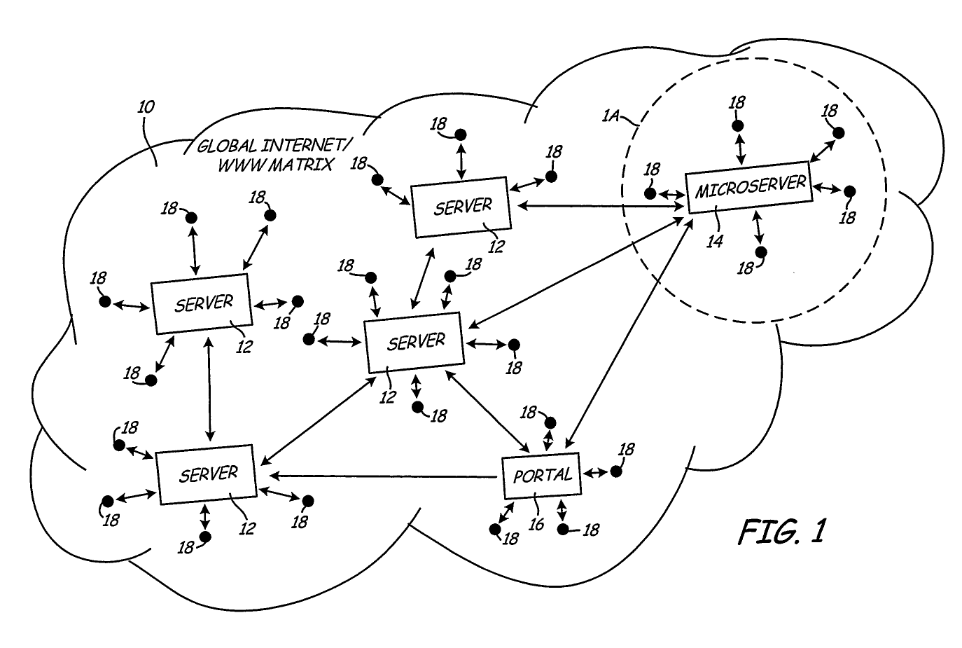

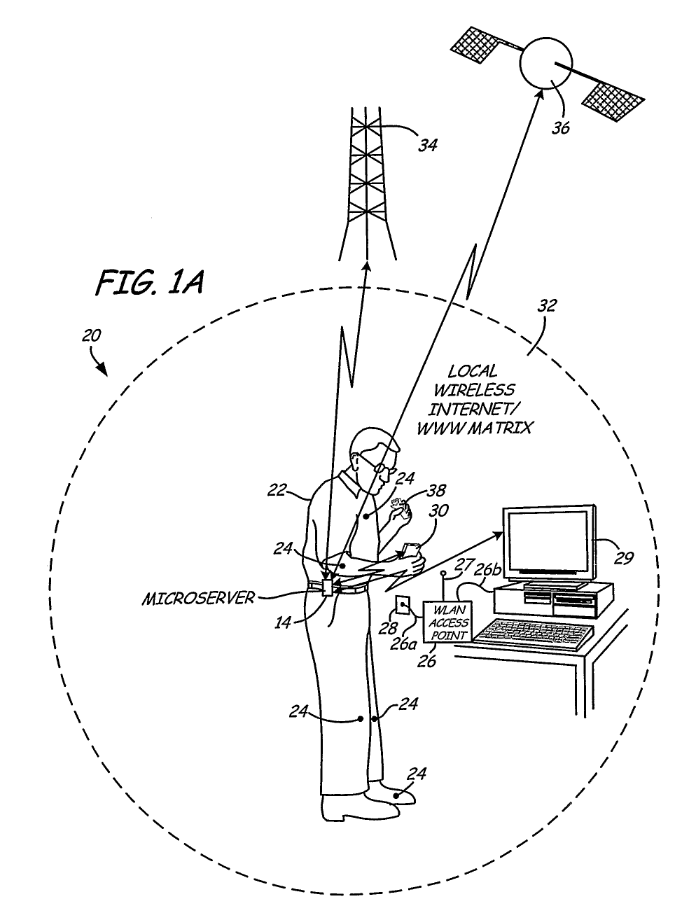

FIG. 1 is a schematic of the present invention of a personal microserver system as part of global Internet/world wide web matrix 10. Matrix 10 as shown in FIG. 1 includes plurality of general servers 12, microserver 14, and portal 16. Matrix 10 represents the global world wide web which, in reality, may include a virtually unlimited number of servers. For illustrative purposes, only a few servers are shown in FIG. 1. As explained in more detail below, microserver 14 and portal 16 are also servers that function essentially similar to general servers 12.

General servers 12, microserver 14 and portal 16 are each shown in FIG. 1 as having connections to plurality of nodes 18. General servers 12, microserver 14 and portal 16 are each fully privileged web servers configured to manage large numbers of nodes 18 and route data requests to and from other web servers on the Internet through matrix 10. Any of these servers may commonly be configured in a clustered, hierarchical structure of servers within a private network.

Each of nodes 18 represent a computing device connected to one of the servers in FIG. 1 (general servers 12, microserver 14 or portal 16) and are assigned a temporary IP address by the fully privileged web server. Thus, nodes 18 are clients that connect to a server. The computing devices represented by nodes 18 use a local web browser to connect to the world wide web through one of servers 12, 14 or 16, as shown in FIG. 1.

Two-way arrows are shown in FIG. 1 to represent two-way wireless communications between servers 12, 14 and 16, as well as between nodes 18 and its respective server. It is also recognized that any of these communications could also be through a wired connection.

FIG. 1A is an exploded view of microserver 14 from FIG. 1, which illustrates how microserver 14 functions in personal microserver system 20 to act as a communications gateway between person 22 and his/her environment. System 20, as shown in FIG. 1A, includes microserver 14, person 22, a plurality of sensors 24, WLAN access point 26 having antenna 27, and local computing devices 29 and 30.

Microserver 14 of the present invention is designed to be a small device that can be worn by a living organism, either directly on the body, on an item of clothing, or even implanted inside the body. Microserver 14 is shown in FIG. 1A clipped onto a clothing item of person 22. As another possibility, microserver 14 may be small enough to be worn in a pocket of a clothing item or contained within a device similar to a wrist watch.

Sensors 24 are connected to microserver 14 either through a wired or wireless connection and are either placed externally on person 22 or implanted inside person 22. Sensors 24 are configured for sensing various parameters, including a variety of physiological conditions, as described in more detail below.

Microserver 14 is configured to collect, store and process data from sensors 24, and convert the data into usable information that may be communicated to person 22 locally and to any number of locations remote to person 22. Microserver 14 includes an antenna and communicates with WLAN access point 26 having antenna 27, thus generating a local wireless field around person 22, as indicated in FIG. 1A by a dashed circle centered around microserver 14 and labeled local wireless Internet/world wide web matrix 32. WLAN access point 26 includes wire 26a running to jack 28 in a wall in order to provide access to the global world wide web. As stated above, microserver 14 includes a web server that allows microserver 14 to host its own web page that is dedicated to person 22. Two-way wireless communications between microserver 14 and remote computing devices is possible through global matrix 10, as discussed in more detail below.

As shown in FIG. 1A, as an alternative or in addition to WLAN access point 26, wireless communications to and from microserver 14 may be made via cellular tower 34 and/or satellite 36. Any of these three primary means for wireless communications may be used in preferred embodiments to access and communicate through global Internet/world wide web matrix 10. However, it is recognized that any other type of communications means may also be used. Microserver 14 may be equipped with standard wired and wireless interfaces, including, but not limited to, USB, serial, optical, Blue Tooth, ZIGBEE, WLAN, and other standard protocols that allow microserver 14 to attach easily to sensors 24.

Microserver 14 may be configured for any type of communications means, including voice and text. In addition to functioning to as a stand-alone computer processor and web based server, microserver 14 may include capabilities for functioning as a digital phone and/or a personal digital interface.

Because microserver 14 generates local wireless Internet/world wide web matrix 32 around person 22, local computing devices within this local wireless system are able to communicate with microserver 14. As shown in FIG. 1A, such local computing devices may include desktop computer 29 and PDA 30. (Wire 26b is shown connecting computer 29 to WLAN access point 26; however, it is recognized that computer 29 and WLAN access point 26 may also be connected wirelessly.) Person 22 may access data locally from microserver 14 using any type of computing device. Such local communications may be wireless, as indicated by the two way arrows from microserver 14 to computer 29 and from microserver 14 to PDA 30. Alternatively, microserver 14 may have a wired connection to local computing devices. In addition to person 22, other users located within the wireless field generated around microserver 14 may also access data locally from microserver 14 using any type of computing device, so long as they have authorization by person 22.

For remote communications, system 20 may be configured such that portal 16 (see FIG. 1) accesses data from microserver 14 remotely through global matrix 10. In addition to or as an alternative to portal 16, other remote computing devices may access data from microserver 14 through general servers 12 by logging onto the unique Internet web address hosted by microserver 14 and dedicated to person 22.

A portal is defined herein as a managed community of servers, normally including a central server, configured to manage, sort and authenticate large numbers of users into virtual communities. An advantage of portal 16 is that it limits access to certain users and makes it easier to manage a large number of servers. Data gathered by microserver 14 may be downloaded to portal 16 as desired. For example, microserver 14 may be programmed to periodically download data to portal 16 or to download data on specific events. Portal 16 may also upload data to microserver 14. Although microserver 14 is capable of analyzing and sorting data, portal 16 may also be provided with a number of software tools that analyze, organize and sort the data from microserver 14.

An advantage of portal 16 is that its functionality may be carried out in a secure, user friendly, web-based environment. Different portions of the data from microserver 14 may be made available to different users through portal 16. Portal 16 functions as a central server that limits access to specified users. For example, these users may log in to portal 16 by presenting an identification and/or a password. Multiple users may access portal 16 simultaneously through any type of computing device, including computers and PDAs. A cellular phone may also be used to access portal 16.

Microserver 14 may be used to monitor the status of person 22 using sensors 24 and communicate that status in real-time locally or remotely. Sensors 24 may be configured to monitor any type of physiological condition of person 22, including, but not limited to, body temperature, blood pressure, blood sugar levels, and heart rate. Sensors 24 may include dumb sensors that sense at least one parameter and communicate the sensed parameter to microserver 14, as well as intelligent sensors capable of some data processing. Moreover, sensors 24 may include sensors with subsystem microservers configured to communicate wirelessly with microserver 14. The subsystem microservers may host their own web page having an Internet web address that is dedicated to that subsystem of person 22. Sensors 24 may include any type of commercially available sensor, as well as sensors specially configured to operate within system 20.

The capabilities of microserver 14 (i.e. to collect and process data, and communicate that data to a potentially infinite number of parties) may be applied in a variety of contexts, including but not limited to, emergency medical situations, medical monitoring, medical research, personal comfort and optimized convenience.

Microserver 14 and sensors 24 are configured to be placed at various positions on the body and collect data on various physiological conditions of person 22. Thus, microserver 14 may continuously collect and process data locally. A medical provider may access the data remotely through portal 16 or through other general servers 12 by logging onto the web page dedicated to person 22 and hosted by microserver 14. Microserver 14 may be configured with a firewall and other security protocols to ensure that only designated individuals are able to access data from microserver 14. If, as an example, person 22 is diabetic, a medical provider may log onto the web page of person 22 and monitor blood sugar levels of person 22. If the medical provider has prescribed a new medication to person 22, the medical provider may monitor various physiological conditions to analyze the effect of the new medication on person 22.

Although microserver 14 is capable of continuously collecting and storing data from sensors 24, microserver 14 is configurable to control output of the collected data. For example, microserver 14 may be configured such that if blood sugar levels reach a low level, microserver 14 may send an audio alarm to alert person 22 of a potential problem. If the blood sugar levels reach a dangerously low level, microserver 14 may send a message to the medical provider or to an emergency services provider that person 22 may require immediate medical attention. More generally, microserver 14 may be configured to communicate remotely to a plurality of locations if specific parameters are detected by microserver 14.

As stated above, person 22 may access data from microserver 14 locally using computing devices within local wireless Internet/world wide web matrix 32. Similarly, another user located within local matrix 32 may access data from microserver 14, if authorized. Microserver 14 allows person 22 to monitor his or her own physiological conditions. For example, person 22 may monitor his or her own blood sugar levels in real-time, or review data of blood sugar levels over the past given number of days.

By providing the capability for person 22 to monitor his own health information, including monitoring in real-time, microserver 14 has the ability to promote healthier behavior. For example, as shown in FIG. 1A, person 22 is consuming candy bar 38. Microserver 14 is able to show in real-time the negative impact of candy bar 38 on the blood sugar levels of person 22, based on data collected from sensors 24 and processed by microserver 14. Person 22 is able to visually monitor his blood sugar levels using PDA 30, shown in FIG. 1A, which receives data locally from microserver 14. Thus, microserver 14 may function as a powerful tool for person 22 to be more in control of his or her own health.

Microserver 14 may include software capable of making lifestyle recommendations to person 22 based upon parameters sensed by sensors 24. For example, microserver 14 may detect that person 22 is dehydrated and thus send an immediate message to person 22 with a recommendation of the type and amount of beverage required to bring person 22 to a desired state of hydration. Microserver 14 may also be configured to provide recommendations for longer term optimization of health to person 22. For example, data from microserver 14 may be made available remotely to a dietician specializing in vitamins and supplements. By having access to data about person 22, the dietician may recommend a particular combination of vitamins and supplements by sending a communication through microserver 14, or be part of a service that creates, and mails or delivers, customized supplements to the individual.

Microserver 14 may include software that creates a three dimensional model of person 22, with the model representing person 22 in real-time based on parameters from sensors 24. The three dimensional model may be accessed locally through microserver 14 or remotely though the web page dedicated to person 22. The three dimensional model may be used by person 22, for example, to determine why he or she may be experiencing discomfort. The model may also be used by a medical provider when person 22 is in the medical provider's office or when the medical provider is making a diagnosis of person 22 from a location remote from person 22. The three dimensional model may be configured to focus in on a portion or subsystem of person 22 and may provide instructions to person 22 or to the medical provider regarding how to heal or mitigate a particular condition detected by sensors 24. Such instructions may be conveyed visually using the three dimensional model as a guide. The instructions may also be audio or written. The model also may be configured to show past conditions of person 22 based on historical data collected by microserver 14.

Microserver 14 is also configured to be a powerful tool for conducting medical research because it allows test subjects to be located remotely from the research facility, while still allowing a researcher to monitor a test subject in real time. The researcher may access data from microserver 14 remotely by logging onto the web page dedicated to person 22 either through one of general servers 12 or portal 16, as shown in FIG. 1.

Person 22 may easily be part of a test study by granting the researcher access rights to data collected by microserver 14. Because system 20 allows for two-way communications between microserver 14 and other servers, data and data queries may be sent both to and from microserver 14. Thus, the researcher has the ability to send algorithms to microserver 14 in order to monitor for specific parameters in person 22. The researcher may easily send such algorithms to virtually an unlimited number of microservers, making it much easier for the researcher to include a larger number of test subjects in a study. In a situation where the researcher is managing data from a large number of microservers, portal 16 may be preferred.

Microserver 14 may be configured such that if a particular parameter is sensed by sensors 24 and detected by microserver 14, microserver 14 sends a communication to person 22 and person 22 is instructed to record what he is doing at that particular time. For example, if a test researcher suspects that a particular food ingredient or combination of food ingredients causes a specific parameter (i.e. a spike in blood pressure), the test researcher may design an algorithm that sends an audio alarm through microserver 14 when a specified blood pressure is sensed by sensors 24. This audio alarm may alert person 22 to record through microserver 14, what he or she was doing at the time the specific parameter was detected. The recording may be written, audio, visual, or made using any other type of digital recording means. Thus, the test researcher will be able to confirm whether or not the specific food ingredient did or did not cause the increase in blood pressure. An alarm sent through microserver 14 may include additional instructions to person 22, such as, for example, instructions to take a digital photograph using microserver 14.

Microserver 14 may also be configured so that if a particular parameter is sensed and detected by microserver 14, microserver 14 sends a communication to portal 16 or to other remote computing devices, in addition to alerting person 22. Additional algorithms may easily be sent from a remote server to microserver 14 to test for additional or alternative conditions without causing any inconvenience to person 22.

Microserver 14 may alternatively be embedded inside a medical device, (for example, a patch) that is configured for delivering medications or supplements to person 22. Based on data collected from sensors 24, microserver 14 may be programmed to deliver a constant or variable dosage of a medication or supplement to person 22. Conditions may also be monitored remotely, for example by a physician, who may decide if and how much medication to deliver to person 22 through microserver 14.

Microserver 14 is configured for two-way communications with other personal microservers. If a second microserver came into close proximity with microserver 14, the second microserver is detected by microserver 14, and vice versa. The two microservers are thus able to share data directly with one another, assuming authorization is provided. If the second microserver was instead located in a location remote from microserver 14, point-to-point communications between the two microservers is still feasible because the two microservers function like any other general servers communicating via global Internet/world wide web matrix 10.

It is important to emphasize that the personal microserver of the present invention is intended to be controlled at all times by the person wearing it. For example, person 22 of FIG. 1A is in control of who has access to microserver 14. Microserver 14 may be configured such that person 22 has the ability to grant and remove access rights to data from microserver 14 at any time. Microserver 14 may also be configured such that different parties have access to different portions of data collected by microserver 14.

The personal microserver system of the present invention may be used with current Internet protocol (IP) version 4 (IPv4) architecture, but it is recognized that there may be limited scalability. However, IP version 6 (IPv6), which is expected to replace IPv4, will be far more flexible and efficient for implementation of a personal microserver system made available to every individual and with the ability to host a web page dedicated to that individual.

Microserver 14 has a capability to host any type of software application and to be frequently upgraded to host additional or replacement applications. Security protocols of microserver 14 may be managed by person 22 or by other individuals designated to act on behalf of person 22. However, it is recognized that microserver 14 may include an advanced configuration to provide intelligent control. In those embodiments, an intelligent agent within microserver 14 automatically manages all communications and securities for microserver 14.

Although FIG. 1A shows microserver 14 being worn on a clothing item of person 22, microserver 14 may be configured to be implanted inside person 22. Microserver 14 is described and illustrated above as a microserver worn by humans. However, it is recognized that the microserver of the present invention may serve as a digital interface for other types of living organisms, including household pets and other types of animals. This type of microserver system may likely be beneficial for conducting animal research.

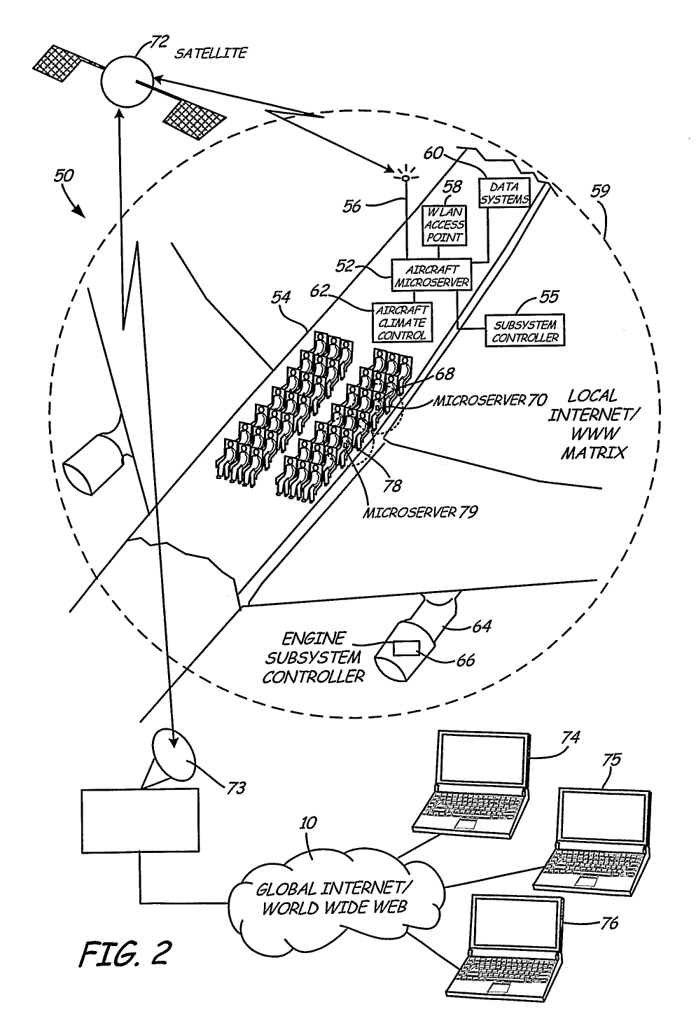

FIG. 2 is a schematic that illustrates use of a personal wearable microserver of the present invention in conjunction with aircraft microserver system 50, which includes onboard microserver 52 installed on aircraft 54. A similar microserver system for a movable platform is described in the following published applications, which are incorporated by reference in their entireties: U.S. Patent Application Pub. No. US 2004/0206818; U.S. Patent Application Pub. No. US 2005/0027826; U.S. Patent Application Pub. No. US 2005/0165534; U.S. Patent Application Pub. No. US 2005/0171651; and U.S. Patent Application Pub. No. US 2006/0015777.

Onboard microserver 52 creates a network centric aircraft maintenance and management architecture that is configured and reconfigurable to perform many applications and roles for aircraft 54. Such applications include hosting technical information and work instructions onboard the aircraft subsystem, tracking RFID (radio frequency identification) tagged parts for maintenance, tracking cargo modules for bagging using RFID, and other operational requirements. The open architecture system created by onboard microserver 52 allows for mass customization to convert various forms of data into usable knowledge without having to install or create new pieces of hardware for each application. Communications to and from microserver 52 may be through a wired or wireless connection, through satellite, cellular phones, wireless local area networks (WLAN), radio, cable or any other communications means.

Onboard microserver 52 is connected to aircraft 54 by subsystem controller 55, and has two-way communications with controller 55. Subsystem controller 55 may be mounted to an engine of aircraft 54 or to another component of aircraft 54, such as an auxiliary power unit or environmental control system. Microserver 52 includes antenna 56 which facilitates communications between microserver 52 and remote locations, as described more below. Microserver 52 is connected to WLAN access point 58, an example of which is IEEE 802.11. WLAN access point 58 creates a wireless field in and around aircraft 54, which makes it possible to have two-way wireless communications between aircraft 54 and any local computing device through local Internet/world wide web matrix 59. Microserver 52 also facilitates two-way wireless communications with a remote computing device through global matrix 10 of FIG. 1.

Microserver 52 is also shown in FIG. 1 having connection to aircraft data systems 60 and aircraft climate control 62. Aircraft data systems 60 facilitates maintenance of aircraft 54. Because microserver 52 is a fully privileged web server, like microserver 14 described and shown above, microserver 52 similarly hosts a web page having an Internet web address dedicated to aircraft 54. Microserver 52 allows access to maintenance information on aircraft 54 to designated individuals, such as aircraft technicians. Aircraft climate control 62 of aircraft 54, also connected wired or wirelessly to microserver 52, makes it possible to have two way wireless communications between climate control 62 and other servers, as explained in more detail below. Specific components or subsystems of aircraft 54 may each have their own microserver that is similar to microserver 52. For example, engine 64 as shown in FIG. 1 includes subsystem controller 66. Thus, engine 64 may have its own unique web page dedicated to that engine.

Microserver 52 includes antenna 56, which creates a hotspot around aircraft 54. Any user on aircraft 54 can login locally to microserver 52 through local Internet/world wide web matrix 59 using any type of local computing device. As shown in FIG. 2, person 68 having personal microserver 70 is located on aircraft 54. Personal microserver 70 is similar to microserver 14 shown in FIGS. 1 and 1A and described above.

Because personal microserver 70 is located within local matrix 59 created around aircraft 54, personal microserver 70 is able to communicate wirelessly with onboard microserver 52 using WLAN access point 58. Onboard microserver 52 is already implemented on aircraft 54 and performs maintenance and support functions for aircraft 54. Thus, as shown in FIG. 2, personal microserver 70 is simply another web server temporarily located within local Internet/world wide web matrix 59.

Personal microserver 70 is thus able to communicate locally with onboard microserver 52. Onboard microserver 52 also facilitates communications between personal microserver 70 and global Internet/world wide web matrix 10. Antenna 56 makes it feasible for onboard microserver 52 to send communications through global matrix 10 using, as an example, space satellite 72 and ground-based satellite 73. In addition to satellite 72, other communications means, including but not limited to radio frequency, ground-based WLAN, and cellular may also be used for remote communications through global matrix 10. An authorized user or users may access data from microserver 52 using any type of computing device through global matrix 10. For example, a plurality of computers 74, 75 and 76, as shown in FIG. 2, may access data from microserver 52. Because personal microserver 64 has local wireless communications with microserver 52, computers 74, 75 and 76, if authorized, may also access data from personal microserver 70.

As an example, if personal microserver 70 detected that person 68 was experiencing a medical emergency, such as a heart attack, personal microserver 70 may relay a message to onboard microserver 52 that immediate medical attention is needed. Onboard microserver 52 may then communicate this message locally to parties on aircraft 54, as well as remotely through global matrix 10. A message may be sent to a physician (not shown) who may be standing in front of computer 76. Because system 50 facilitates two-way communications, remote parties, such as a physician, may send instructions through microserver 52 that specifically address the needs of person 68 in a medical emergency.

In addition to medical monitoring, personal microserver 70 may be used to optimize comfort of person 68 on aircraft 54. Aircraft climate control 62, which controls an air temperature inside aircraft 54, is connected to onboard microserver 52 and thus is able to communicate with personal microserver 70 when microserver 70 is located within local Internet/world wide web matrix 59 created in and around aircraft 54. Although not visible in FIG. 2, personal microserver 70 may be connected, wired or wirelessly, to a plurality of sensors on person 68, similar to sensors 24 described above. These sensors may include temperature sensors that continuously monitor a body temperature of person 68. Body temperature data from the sensors on person 68 is collected by personal microserver 70 and may be communicated locally to onboard microserver 52. Aircraft climate control 62, having a connection to microserver 52, may then make adjustments to an air temperature around person 62 based on body temperature data from microserver 70. For example, if microserver 70 communicates that person 68 has a body temperature that is higher than normal, aircraft climate control 62 may make adjustments to lower the air temperature around person 68.

Another person on aircraft 54, such as second person 78 located near person 68, may have second personal microserver 79. Second personal microserver 79 may communicate to climate control 62 that second person 78 has a body temperature lower than normal. Aircraft climate control 62 may then simultaneously make adjustments to increase the air temperature around second person 78, while still lowering the air temperature around person 68. Thus, personal microservers 70 and 79 and onboard microserver 52 are configured to work in combination for microclimate control to maximize comfort for persons 68 and 78 on aircraft 54.

The personal wearable microserver described herein may similarly communicate with microservers on any other type of movable platform, including other types of aircraft, spacecraft, land vehicles and marine vehicles. Aircraft 54 having onboard microserver 52 is described herein and shown in FIG. 2 as an example of how a personal wearable microserver is configured to communicate with other server systems.

As illustrated by FIG. 2, the personal microservers of the present invention are configured to communicate with a microserver on a movable platform. As also discussed above in reference to FIG. 1A, the personal microservers are also configured to communicate with one another, either locally or remotely. Person 68 and second person 78 both have local wireless systems that overlap one another, as illustrated by the dashed circles in FIG. 2. Thus, microserver 70 and second microserver 79 may communicate locally with one another.

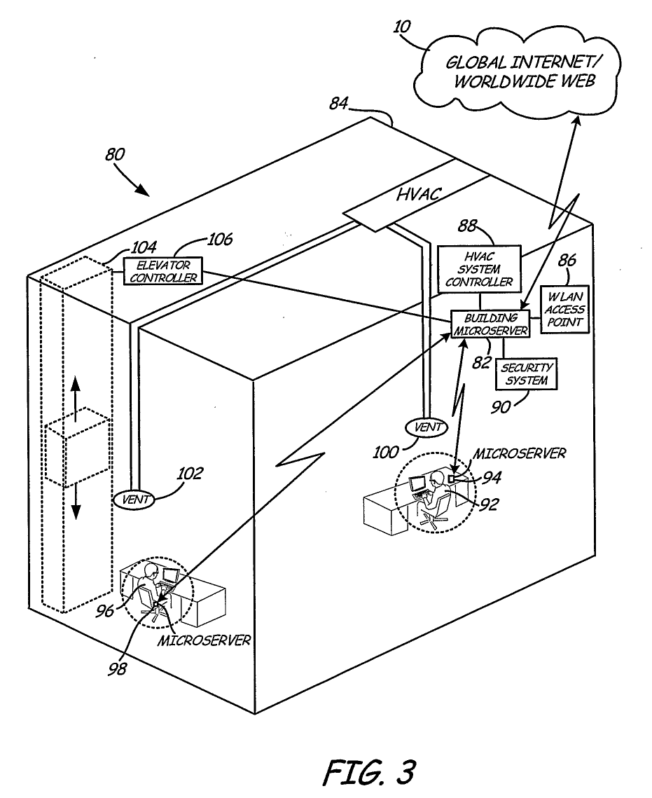

FIG. 3 is a schematic that illustrates use of a personal wearable microserver in conjunction with building network system 80 in order to maximize comfort and convenience for people located inside building 84. Building 84 includes building microserver 82 which, as shown in FIG. 3, is connected (wired or wirelessly) to WLAN access point 86, HVAC system controller 88, and security system 90.

Similar to WLAN access point 58 of aircraft 54 shown in FIG. 2, WLAN access point 86 provides wireless network connectivity within building 84. As shown in FIG. 3, first person 92 having personal microserver 94 and second person 96 having personal microserver 98 are both located inside building 84. Dashed circles around persons 92 and 96 represent a local wireless field created by personal microservers 94 and 98. Two-way arrows between microserver 94 and building microserver 82, and microserver 98 and building microserver 82 indicate two-way wireless communications from microservers 94 and 98 to building microserver 82. Similar to aircraft microserver system 50 of FIG. 2, network system 80 allows for local wireless communications, as well as remote communications through building microserver 82.

Building microserver 82 may be used to control a temperature inside building 84 through HVAC (heating, ventilation, and air conditioning) system controller 88. Because HVAC system controller 88 and microservers 94 and 98 are all located within a local internet/world wide web matrix inside and around building 84, controller 88 may communicate with microservers 94 and 98 through building microserver 82. Similar to the aircraft climate control described above under FIG. 2, microclimate control inside building 84 is made possible via building microserver 82. For example, if microserver 94 communicates to building microserver 82 that first person 92 is running a fever, building microserver 82 may communicate to HVAC system controller 88 to blow cold air through vent 100 located directly above the desk of person 92. On the other hand, if microserver 98 communicates that a body temperature of second person 96 is below normal, building microserver 82 may communicate to HVAC system controller 88 to blow warm air through vent 102 located above the desk of person 96. Thus, HVAC system controller 88 is capable of adjusting the temperature differently in different parts of the building based on the comfort of each individual. HVAC system controller 88 may be configured to include its own subsystem microserver that communicates with building microserver 82.

Similarly, because network system 80 is configured to detect a general physical location of people within building 84, HVAC system controller 88 may be configured to turn on and off based on a number of people located within building 84. For example, if second person 96 is working past normal business hours and it is cold outside, microserver 98 will be detected inside building 84 and HVAC system controller 88 will continue to blow warm air to an area of building 84 where person 96 is located. However, to conserve energy, HVAC system controller 88 will not deliver the same amount of heat to other areas of building 84.

Security system 90, which is also connected to building microserver 82, may be used for tracking a general location of persons 92 and 96 inside building 84 through microservers 94 and 98, respectively. Security system 90 may be configured such that an alarm is sent locally and remotely if a person is detected within a restricted area.

Two way communications between microservers 94 and 98 and building microserver 82 may also aid in emergency situations. If, for example, person 92 was experiencing a medical emergency while inside building 84, microserver 94 may send an emergency communication to a location remote from building 84. Remote communications are feasible via building microserver 82 and through to global internet/world wide web 10. However, microserver 94 may also send a communication locally to building microserver 82 that person 92 requires immediate medical attention. Building microserver 82 is capable of communicating this to an appropriate party, which may be, for example, an emergency response team designated within building 84. Building microserver 82 is also able to detect a general physical location of person 92 based on wireless tracking of microserver 94. Similarly, microservers 94 and 98 may be configured to display a map of building 84 which shows a general location of persons 92 and 96 inside building 84, and the map may include locations of particular features within building 84. Microservers 94 and 98 may provide directions to person 92 and 96, respectively, to a particular location inside building 84 based on the detected location of persons 92 and 96.

As discussed above, microservers 94 and 98 are configured to communicate locally with one another. If first person 92 and second person 96 are located within close proximity to each other, microservers 94 and 98 are able to communicate directly. As shown in FIG. 3, persons 92 and 96 are located far enough apart from one another that their local wireless fields created by microservers 94 and 98 do not overlap. However, microservers 94 and 98 are still able to communicate through building microserver 82 which facilitates local wireless communication in and around building 84.

Although specific applications of a personal wearable microserver are described herein, it is recognized that the personal microserver of the present invention may be used in a virtually unlimited number of contexts. For example, as also shown in FIG. 3, microservers 94 and 98 may be used within building 84 for communicating with elevator system 104 inside building 84. As shown in FIG. 3, building microserver 82 is connected to controller 106 of elevator system 104 such that building microserver 82 is able to facilitate two way communications between microservers 94 and 98 and controller 106 of elevator system 104. Thus, controller 106 may track a general location of persons 92 and 96 within building 84 and detect when person 92 or 96 is approaching an elevator within building 84. Through building microserver 82, controller 106 of elevator system 104 may be equipped with identification and authorization information such that elevator system 104 knows which floors persons 92 and 96 have access to. Controller 106 may be able to confirm through communications with microservers 94 and 98 whether persons 92 and 96 have access to specific areas of building 84 which persons 92 and 96 request to go to. Moreover, controller 106 of elevator system 104 may communicate with microservers 94 and 98 of persons 92 and 96, respectively, to address any possible special needs of each individual person. As similarly discussed above in reference to HVAC system controller 88, elevator controller 106 may also be configured to include its own subsystem microserver that communicates with building microserver 82.

In another example, microservers 94 and 98 may communicate with building microserver 82 to determine a location of a restroom (not shown) inside building 84. As discussed above, because a general location of person 92 within building 84 is detected through building microserver 82, microserver 82 may send directions to microserver 94 instructing person 92 how to find the nearest restroom within building 84 based on the tracked location of person 92. It is recognized that the scope and application of a personal wearable microserver of the present invention is not limited to the applications described herein and may be used in numerous applications to facilitate communication between an individual and his or her environment.

Although the present invention has been described with reference to preferred embodiments, workers skilled in the art will recognize that changes may be made in form and detail without departing from the spirit and scope of the invention.

1-67. (canceled)

68. An integrated system for creating a digital interface between a living organism and its environment locally and remotely, the system comprising:
data collection apparatus disposed on or around the living organism; and
a microserver configured to function as a local computing workstation and a web data gateway having its own web page and corresponding Internet web address on a world wide web, and be located inside, on or in close proximity to the living organism and create a wireless system around the living organism, wherein the microserver is in communication with the data collection apparatus and capable of retrieving, monitoring and analyzing data from the data collection apparatus.

69. The integrated system of claim 68 wherein the data collection apparatus includes at least one sensor disposed on or in a body of the living organism for sensing at least one parameter of the living organism.

70. The integrated system of claim 68 wherein the at least one sensor includes an intelligent sensor capable of analyzing data.

71. The integrated system of claim 68 wherein the microserver hosts a three-dimensional model of the living organism, and the model provides real-time imaging of the living organism based on data from the data collection apparatus.

72. The integrated system of claim 68 further comprising means for enabling two-way communications with the microserver from a remote location.

73. The integrated system of claim 68 wherein the microserver is capable of communicating with a second server.

74. The integrated system of claim 73 wherein the second server communicates with an intelligent controller of the living organism's environment, and the microserver relays data from the data collection apparatus to the intelligent controller, the controller being configured to make adjustments based on a real-time feedback loop of data from the microserver.

75. The integrated system of claim 74 wherein the intelligent controller is part of a heating and cooling system.

76. The integrated system of claim 74 wherein the intelligent controller is part of an elevator system.

77. The integrated system of claim 73 wherein the second server is a microserver configured to be located inside, on or in close proximity to a second living organism.

78. The integrated system of claim 68 wherein the microserver communicates with a second microserver integrated with a movable platform and capable of communicating with a global Internet.

79. A system for creating a digital interface between an individual and its environment, the system comprising:
a microserver configured to reside inside, on or near the individual and create a local world wide web around the individual, wherein the microserver is configured to retrieve, store and analyze data, and host a web page having an IP address and dedicated to the individual;
at least one sensor configured for sensing at least one parameter of the individual, wherein the at least one sensor communicates sensed parameters to the microserver; and
at least one remote computing device located remote from the individual, wherein the at least one remote computing device is able to communicate with the microserver and access data from the microserver through a global world wide web.

80. The system of claim 79 wherein the microserver is configured to restrict access to data from the microserver to designated individuals.

81. The system of claim 79 further comprising at least one local computing device located within the local world wide web and capable of communicating with the microserver locally.

82. The system of claim 79 wherein the at least one remote computing device provides updated algorithms to the microserver, wherein the algorithms are designed to detect specific parameters by the data collection apparatus, and the microserver is configured to communicate to at least one of the individual and the at least one remote computing device when specific parameters are detected.

83. The system of claim 79 wherein the microserver includes software to create a three-dimensional model of the individual, the model being capable of providing a real-time image of the individual based on parameters sensed from the at least one sensor.

84. The system of claim 83 wherein the three-dimensional model is capable of providing instructions for mitigating or healing a particular condition displayed on the three-dimensional model.

85. The system of claim 79 wherein the microserver is capable of communicating with a second microserver.

86. The system of claim 85 wherein the second microserver communicates with an intelligent controller of the individual's environment.

87. The system of claim 86 wherein the intelligent controller includes at least one of a controller for a heating and cooling system and a controller for an elevator system.

88. A method of creating a digital interface between a living organism and its environment, the method comprising:
sensing parameters of the living organism using at least one sensor located on or imbedded inside the living organism;
relaying sensed parameters to a microserver located on, inside or near the living organism;
converting data from sensed parameters into usable information using the microserver; and
communicating the usable information to the living organism and to locations local and remote from the living organism.

89. The method of claim 88 further comprising:
communicating usable information to a second server having a local wireless area network that the microserver is contained within.

90. The method of claim 89 wherein the second server is located in a building and is associated with a controller of a heating and cooling system of the building, and the heating and cooling system makes adjustments to a temperature of an area of the building where the living organism is located based on data from the microserver.

91. The method of claim 89 wherein the second server is located in a building and is associated with a controller of an elevator system of the building, and the elevator system is configured to respond to communications from the microserver.

92. The method of claim 89 wherein the second server is located on a movable platform and facilitates communications between the microserver and remote computing devices through a global Internet.
